(19) United States
(12) Patent Application Publication
(10) Pub. No.: US 2025/0360498 A1
(43) Pub. Date: Nov. 27, 2025

(54) CATALYST-LOADED HONEYCOMB ARTICLE HAVING IN-WALL AND ON-WALL CATALYST DEPOSITION AND METHOD OF MANUFACTURE

(71) Applicant: CORNING INCORPORATED, CORNING, NY (US)

(72) Inventors: Douglas Munroe Beall, Painted Post, NY (US); Vishwanath Ganpat Deshmane, Chesterbrook, PA (US); Min Shen, Horseheads, NY (US)

(21) Appl. No.: 18/707,635

(22) PCT Filed: Nov. 9, 2022
(86) PCT No.: PCT/US2022/049338

§ 371 Date: May 6, 2024

Related U.S. Application Data
(60) Provisional application No. 63/282,498, filed on Nov. 23, 2021.

(51) Int. Cl. B01J 37/02; B01D 46/24; B01D 53/94; B01J 23/46; B01J 35/57; B01J 35/64; F01N 3/10; F01N 3/28

(52) U.S. Cl. CPC B01J 37/0228; B01D 46/24491; B01D 46/24492; B01D 46/2474; B01D 46/2482; B01D 53/945; B01J 23/464; B01J 35/57; B01J 35/657; B01J 37/0236; F01N 3/101; F01N 3/2828; B01D 2255/1025; B01D 2255/2092; B01D 2255/9155; B01D 2255/9202; B01D 2255/9205; B01D 2258/01; B01D 2279/30; F01N 2330/06; F01N 2330/48; F01N 2370/02

(57) ABSTRACT

A catalyst-loaded porous ceramic honeycomb article and method of manufacture. The ceramic honeycomb article comprises an array of intersecting walls defining channels extending axially through the ceramic honeycomb article. The method comprises depositing catalyst material within a pore structure of a porous ceramic material of the walls in a first deposition process comprising a first set of deposition parameters to form an in-wall portion of a catalyst deposition. Catalyst material is deposited onto outer surfaces of the walls in a second deposition process comprising a second set of deposition parameters that differ from the first set of deposition parameters to form an on-wall portion of the catalyst deposition. The second deposition process does not increase the in-wall portion of the catalyst deposition to above a target final pore occupancy of the pore structure.

### CROSS REFERENCE TO RELATED APPLICATION

This application claims the benefit of priority under 35 U.S.C. § 119 of U.S. Provisional Application Ser. No. 63/282,498 filed on Nov. 23, 2021, the content of which is relied upon and incorporated herein by reference in its entirety.

### FIELD

This disclosure relates to fluid treatment systems, such as exhaust aftertreatment systems, and more particularly to fluid treatment systems employing a combination of in-wall and on-wall catalyst deposition and methods of manufacture thereof.

### BACKGROUND

Catalyst-loaded substrates can be useful in fluid treatment systems, e.g., the exhaust aftertreatment system of an internal combustion engine vehicle, to abate one or more pollutants. For example, a catalyst washcoat can be deposited within the channels of a honeycomb substrate to enable catalytic conversion to remove or reduce an undesirable component of the exhaust flow. However, the use of such substrates may come at the cost of engine performance, such as an increase of backpressure in the system due to the presence of the substrate. There is an ongoing desire for aftertreatment systems and methods that enable higher conversion efficiency and/or lower engine performance tradeoffs.

### SUMMARY

Disclosed herein are methods of manufacturing a catalyst-loaded ceramic honeycomb article comprising an array of intersecting walls defining channels extending axially through the ceramic honeycomb article. In embodiments, the method comprises depositing catalyst material within a pore structure of a porous ceramic material of the walls in a first deposition process comprising a first set of deposition parameters to form an in-wall portion of a catalyst deposition; depositing catalyst material onto outer surfaces of the walls in a second deposition process comprising a second set of deposition parameters that differ from the first set of deposition parameters to form an on-wall portion of the catalyst deposition; wherein the second deposition process does not increase the in-wall portion of the catalyst deposition to above a target final pore occupancy of the pore structure.

In embodiments, a porosity of the porous ceramic material of the walls is at least 50%.

In embodiments, a porosity of the porous ceramic material of the walls is at least 60%.

In embodiments, a median pore size of the porous ceramic material of the walls is at least 13 μm.

In embodiments, a median pore size of the porous ceramic material of the walls is at most one-third of a wall thickness of the walls.

In embodiments, the first set of deposition parameters and the second set of deposition parameters differ by one or more of a viscosity, an applied pressure during catalyst deposition, a time span over which the porous ceramic honeycomb article is exposed to catalyst deposition, a solid concentration of a slurry comprising the catalyst material from which the catalyst material is deposited, a mean particle size of particles of the catalyst material, a particle size distribution of particles of the catalyst material, or a combination of one or more of the foregoing.

In embodiments, the first set of parameters includes a viscosity that is less than that used in the second set of parameters, an applied pressure that is greater than that of the second set of parameters, a duration that is longer than that of the second set of parameters, a solid concentration of a slurry comprising the catalyst material from which the catalyst material is deposited that is less than that of the second set of parameters, a mean particle size that is less than that of the second set of parameters, or a combination of one or more of the foregoing.

In embodiments, the first deposition process comprises depositing the catalyst material to an intermediate pore occupancy that is less than or equal to the target final pore occupancy.

In embodiments, the first deposition process comprises depositing the catalyst material to an intermediate pore occupancy that is less than the target final pore occupancy and the second deposition process comprises depositing a supplemental in-wall portion to achieve the target final pore occupancy.

In embodiments, the target final pore occupancy is at most 85%.

In embodiments, the target final pore occupancy is at most 75%.

In embodiments, the target final pore occupancy is at least 15%.

In embodiments, the target final pore occupancy is from 15% to 85%.

In embodiments, a catalytically active component of the catalyst material is the same for both the first deposition process and the second deposition process.

In embodiments, the catalyst material in both the first deposition process and in the second deposition process is arranged as a three-way catalyst.

In embodiments, the catalyst material comprises a combination of alumina, rhodium, and a platinum group metal.

In embodiments, the first deposition process, the second deposition process, or both, comprise multiple stages.

In embodiments, the first deposition process, the second deposition process, or both, comprise drying the ceramic honeycomb article after depositing catalyst material.

In embodiments, the in-wall portion after the first and second deposition processes comprises at least 50% by weight of a total catalyst loading of the catalyst material in the in-wall portion and the on-wall portion.

In embodiments,

Disclosed herein are catalyst-loaded ceramic honeycomb articles. In embodiments, the catalyst-loaded ceramic honeycomb article comprises an array of intersecting walls defining channels extending axially through the ceramic honeycomb article, wherein a porous ceramic material of the intersecting walls comprises: a porosity of at least 60%; a wall thickness from between 2 mils and 6 mils; a median pore size of 13 μm to 25 μm; and a catalyst material deposition comprising: an in-wall portion occupying from 15% to 85% of a volume of a pore structure of the porous ceramic material; and an on-wall portion on outer surfaces of the walls within the channels, wherein the in-wall portion comprises at least 30% of a total loading of the catalyst material and the on-wall portion comprises at least 20% of the total loading of the catalyst material.

In embodiments, the in-wall portion comprises at least 50% of the total loading of the catalyst material.

It is to be understood that both the foregoing general description and the following detailed description are merely exemplary, and are intended to provide an overview or framework to understanding the nature and character of the claimed subject matter. The accompanying drawings are included to provide a further understanding and are incorporated in and constitute a part of this specification. The drawings illustrate one or more embodiment(s), and together with the description, serve to explain principles and operation of the various embodiments.

### BRIEF DESCRIPTION OF THE DRAWINGS

FIG. 1 is a perspective view of a ceramic honeycomb article according to embodiments disclosed herein.

FIGS. 2A and 2B are SEM cross-sectional images showing the microstructure of a porous ceramic honeycomb article according to embodiments disclosed herein.

FIG. 3 schematically illustrates a microstructure of a porous ceramic article comprising an in-wall catalyst deposition portion and an on-wall catalyst deposition portion according to embodiments disclosed herein.

FIGS. 4A and 4B are graphs showing cumulative carbon monoxide output at two different times during an example operating cycle of an engine for four Example honeycomb articles loaded with catalyst material to different in-wall portion pore occupancies.

FIGS. 5A-5C schematically illustrate a porous ceramic article during three stages of a catalyst deposition process according to embodiments disclosed herein.

FIGS. 6A-6C are SEM cross-sectional images showing walls or portions thereof of the porous ceramic honeycomb article of FIGS. 2A-2B after depositing catalyst material in a first deposition process to form an in-wall portion having a pore occupancy of approximately 70% according to one example.

FIG. 7 shows a flow chart describing a method of manufacturing a catalyst-loaded substrate according to embodiments disclosed herein.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

Numerical values, including endpoints of ranges, can be expressed herein as approximations preceded by the term “about,” “approximately,” or the like. In such cases, other embodiments include the particular numerical values. Regardless of whether a numerical value is expressed as an approximation, two embodiments are included in this disclosure: one expressed as an approximation, and another not expressed as an approximation. It will be further understood that an endpoint of each range is significant both in relation to another endpoint, and independently of another endpoint.

According to embodiments disclosed herein, a catalyst-loaded ceramic honeycomb article can be manufactured utilizing a two-step catalyst deposition process in which an in-wall deposition process is followed by an on-wall deposition process and results in a catalyst-loaded honeycomb article exhibiting good catalytic performance and a favorable backpressure. As described herein, the functional in-wall catalyst portion enables a thinner on-wall coating to be utilized, which advantageously enables a greater hydraulic diameter through the honeycomb channels (due to less of the channels being filled by the thinner on-wall coating), which results in a lower back pressure at comparable catalyst conversion efficiency.

According to embodiments herein, the volume of the porous ceramic structure filled by the catalyst material, which may be referred to herein as the pore occupancy, is controlled in a two-step process for the in-wall and on-wall portions of the catalyst. By controlling the in-wall and on-wall catalyst deposition, effective access of the fluid flow (e.g., exhaust flow) to the reaction sites of the in-wall catalyst is maintained, which advantageously enables reactivity of the in-wall catalyst material deposited within the pore network of the ceramic material. Namely, by controlling the in-wall and on-wall deposition processes to maintain unoccupied spaces in the pore structure of the base ceramic honeycomb body, and to enable use of a relatively thinner on-wall portion, the sufficient diffusion of reactive species of the fluid flow (e.g., carbon monoxide, nitrous oxides, or other species in an exhaust flow) can be achieved to ensure catalytic performance.

According to embodiments herein, a ceramic honeycomb article comprising a high porosity (e.g., at least 50%, 55% or even 60% porosity), large pore size (e.g., 13 μm-23 μm median pore size, and/or up to one-third the wall thickness of the ceramic honeycomb article) enables high in-wall loading of a catalyst washcoat. However, it has been found that heavily loading the pore structure with catalyst material (e.g., 90% volume or more pore occupancy) may negatively impact diffusivity by limiting availability of some of the catalyst material from participating in reactions. Accordingly, in embodiments, the ceramic honeycomb article is loaded with an in-wall catalyst to a pore occupancy (by volume) that retains some amount of unoccupied pore structure, such as to a pore occupancy of between about 15%-85% or subranges therewithin. In this way, effective diffusion of the reactive species (e.g., carbon monoxide, NOx) in the fluid flow is enabled through the unoccupied pores, which provides access of the reactive species to the in-wall catalyst material, e.g., platinum group metal (PGM) catalyst material, to take part in the targeted catalytic reactions. In embodiments, the ceramic honeycomb articles herein can be loaded with a total three-way catalyst material loading (e.g., a total three-way catalyst washcoat loading or three-way catalyst WCL) relative to a volume of the honeycomb structure that is comparable to the total three-way catalyst material loadings utilized on traditional catalyst substrates having on-wall coatings only, such as 150 g/L or more, 200 g/L or more, 250 g/L or more, or even 300 g/L or more, such as in the range of 150 g/L to 350 g/L.

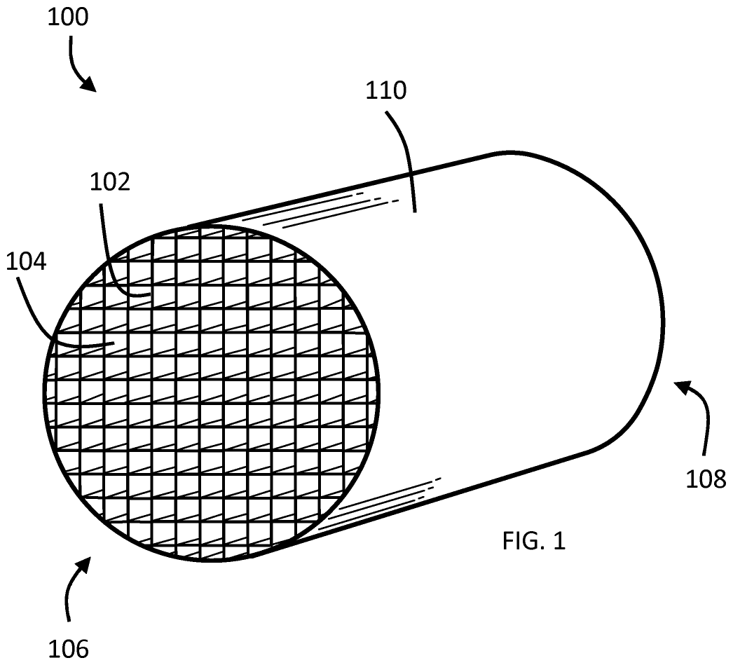

Referring now to FIG. 1, a porous ceramic honeycomb article 100 is schematically depicted. The term “honeycomb” as used herein is defined as a structure of longitudinally- (or axially-) extending channels, e.g., formed from, within, or through a body. Accordingly, the porous ceramic honeycomb article 100 generally comprises an array or matrix or intersecting walls 102 defining a plurality of channels 104 extending between a first end 106 and a second end 108. The set of walls 102 defining each of the channels 104 may be referred to as a cell. The porous ceramic honeycomb article 100 can also comprise an outer periphery or skin 110 formed about and surrounding the matrix of intersecting walls 102 and channels 104. The skin 100 can be extruded during the formation of the walls 102 or formed in later manufacturing step as an after-applied skin, such as by applying a cement to the outer periphery of the inner honeycomb matrix. As described herein, the walls 102 comprise a porous ceramic material suitable for carrying a catalyst material. Accordingly, the porous ceramic honeycomb article 100 may be referred to as a substrate or a catalyst substrate. In embodiments, the porous ceramic honeycomb article 100 may be additionally arranged as a particulate filter and/or used to filter particulate matter from a fluid flow (exhaust stream) by plugging the channels 104 at opposite end faces 106, 108 in a pattern, such as a checkerboard pattern.

In embodiments, including that illustrated in FIG. 1, the walls 102 intersect to define the plurality of channels 104 as being square-shaped in cross section. However, in embodiments, the walls 102 can be alternatively arranged to define the channels 104 with any desired cross-sectional shape, including rectangular, round, oblong, triangular, octagonal, hexagonal, trapezoidal, polygonal, or combinations thereof. Additionally, the honeycomb article 100 can comprise the channels 104 having multiple different shapes and sizes in a single article.

The porous ceramic honeycomb article 100 can be formed by any suitable process, such as extrusion, molding, casting, additive manufacturing, or the like. For example, in embodiments, a ceramic precursor batch mixture can first be made, and the batch mixture then shaped into a green honeycomb body (e.g., extruded through a honeycomb extrusion die), which green honeycomb body is dried and then fired under conditions suitable to react and/or sinter ceramic precursor particles in the green body into one or more ceramic phases for the porous ceramic material of ceramic honeycomb article 100. As described herein, after the green honeycomb structure is fired to form the porous ceramic honeycomb article 100, the porous ceramic honeycomb article 100 is loaded with a catalyst material, e.g., washcoated with a catalyst-containing washcoat.

For example, a batch mixture can comprises a combination of inorganic particles, a pore-former, an organic binder, a liquid vehicle, a lubricant, and other additives to assist in extrusion, green handling, firing, and/or setting one or more properties of the porous ceramic material. The inorganic particles can comprise alumina, silica, magnesia, titania, spinel, clay, such as kaolin clay, talc, mullite, cordierite, or other ceramic or ceramic-forming particles (collectively, ceramic precursors), including combinations thereof. The pore former can comprise a starch, polymer, graphite, or other material that is removed during firing or otherwise changes form to create pore voids in the ceramic material during firing. The binder can comprise a material such as methylcellulose to assist in providing formability of the batch mixture into the green honeycomb body and/or to impact green strength to the green honeycomb body. The liquid vehicle can comprise water or other liquid to assist the batch mixture to flow and/or be shaped into the green honeycomb body. The lubricant can comprise oils, fatty acids, or other substances that reduce friction or otherwise change the rheology of the batch mixture, or combinations thereof.

Further examples of porous ceramic materials and methods of manufacture include those disclosed in US Patent Publication No. 2019/0076773 and U.S. Pat. No. 7,648,548, the disclosures of which are hereby incorporated by reference in their respective entireties.

The porous ceramic honeycomb structures described herein generally have a relatively high total porosity (% P), e.g., as measured with mercury porosimetry (all porosities and pore diameters provided herein measured by mercury porosimetry unless indicated otherwise). In embodiments of the porous ceramic honeycomb structures described herein, the total porosity % P is greater than or equal to about 60%, such as greater than or equal to about 65%. In other embodiments, the total porosity % P is less than or equal to about 75%. In embodiments, the total porosity is less than or equal to about 80%. In embodiments, the total porosity % P is in a range having combinations of the preceding values as endpoints, such as from about 60% to about 80%, from about 60% to about 75%, from about 60% to about 70%, from about 60% to about 65%, from about 65% to about 80%, or from about 65% to about 75%.

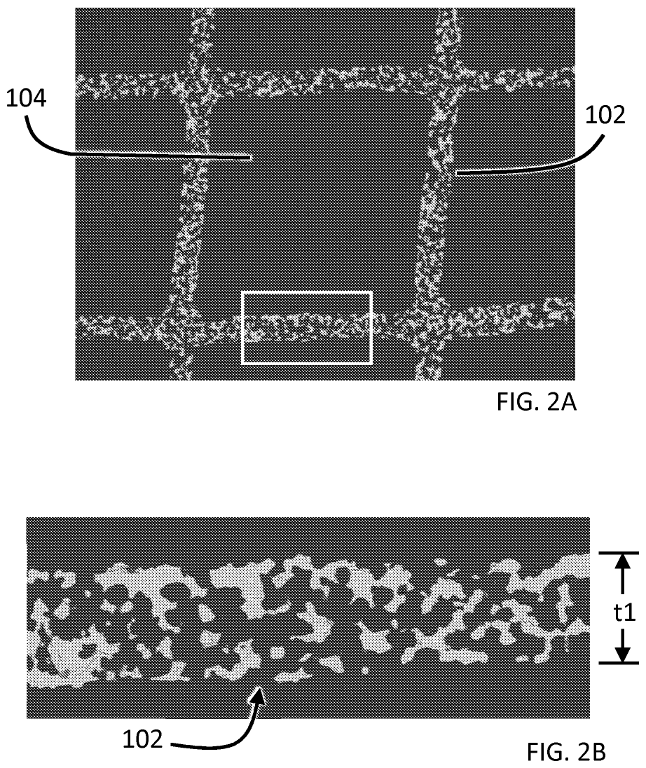

The pores of the porous ceramic honeycomb structures can be arranged in a highly interconnected network structure. The porous ceramic material can comprise one or more ceramic phases, such as cordierite, aluminum titanate, silicon carbide, alumina, silica, mullite, or other. FIGS. 2A and 2B are SEM micrographs of the pore morphology of a polished axial cross section of a single cell and an enlarged view of a portion of a wall, respectively, an example porous ceramic material that can be used for the walls 102, according to an embodiment. In particular, the SEM images of FIGS. 2A and 2B are of a honeycomb body that comprises a porous cordierite material.

An example of a material and microstructure for the porous ceramic honeycomb article 100 is shown in FIGS. 2A-2B. As shown, the walls 102 have a thickness t1(i.e., the dimension of the walls 102 between adjacent channels 104). In particular, FIGS. 2A-2B are SEM cross-sectional of a honeycomb body in which the walls 102 comprise a cordierite material having a porosity of approximately 65%, a median pore size of approximately 19 μm, an average wall thickness (t1) of approximately 3.4 mils (approximately 86 μm), and a geometry of approximately 585 to 600 cells per square inch (cpsi). Thus, using the common nomenclature of “[nominal cpsi]/[nominal wall thickness]”, the honeycomb article depicted in FIGS. 2A and 2B may be referred to as having a “600/3” geometry.

The properties of the ceramic article shown in FIGS. 2A-2B are not limiting. For example, in embodiments, the walls 102 can be as thin as approximately 2 mils (50 μm) and as thick as 10 mils (254 μm) or larger, if desired. In embodiments, the wall thickness t1 can be at least 2 mils, such as from 2 mils to 6 mils, although thicker walls can be utilized. However, thicker walls may increase the overall thermal mass of the ceramic article 100, thereby slowing heating of the ceramic article and delaying catalyst light off in some embodiments. In embodiments, the cells per square inch (cpsi) can be any suitable value, such as 900 cpsi or even high cpsi (smaller channels), or 300 cpsi or lower.

The porous ceramic material of the porous ceramic honeycomb article 100 described herein can have a median pore diameter (d50) greater than or equal to about 13 μm. In embodiments, the median pore diameter (d50) of the porous ceramic honeycomb structure is greater than or equal to about 15 μm, such as greater than or equal to 18 μm or greater than or equal to about 20 μm. In embodiments, the median pore diameter is less than or equal to about one-third of the thickness t1 of the walls 102 (i.e., d50≤t1/3.0). In embodiments, the median pore diameter is less than or equal to about 25 μm. Accordingly, in embodiments, the median pore diameter d50 is from greater than or equal to about 13 μm to less than or equal to about one-third of the wall thickness t1, such as from greater than or equal to about 15 μm to less than or equal to about one-third of the wall thickness t1. In embodiments, the median pore diameter d50 is from greater than or equal to about 13 μm to less than or equal to about 25 μm, such as from greater than or equal to about 15 μm to less than or equal to about 25 μm. Controlling the porosity such that the median pore diameter d50 is within these ranges can effectively limit the amount of very small pores, which can be advantageous since very small pores may limit penetration of catalyst material into the ceramic structure during deposition, and therefore prevent suitable in-wall deposition of catalyst material during a washcoat or other deposition process, for example.

In embodiments described herein, a catalyst material is deposited in-wall and on-wall after firing of the porous ceramic honeycomb article. In embodiments, the catalyst deposition process comprises washcoating with a catalyst washcoat. For example, a slurry of a particulate catalyst washcoating mixture can be applied to the surfaces of the porous ceramic honeycomb article 100. For example, in the embodiments described herein, the deposited catalyst material has one or more active components that provides a catalytic function that promotes catalytic reactions involving the reduction of NOx and/or the oxidation of CO, hydrocarbons, and NO in an exhaust gas stream which is directed through the porous ceramic honeycomb article. In embodiments, the catalyst material is a three-way catalyst system comprising at least alumina, rhodium, and a platinum group metal.

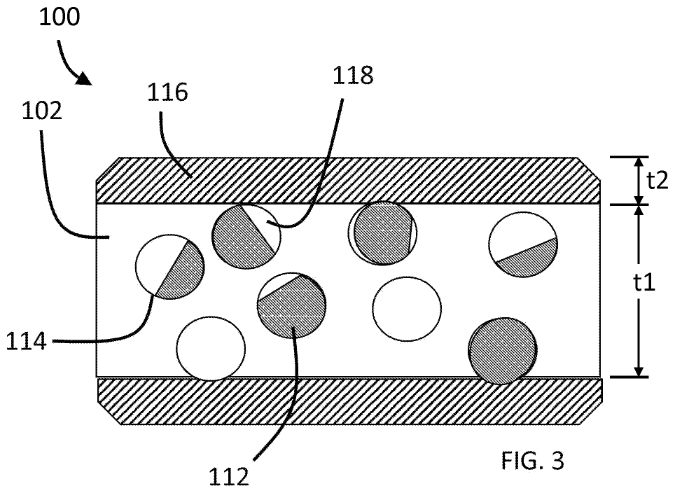

FIG. 3 schematically illustrates a portion of one of the walls 102 of the honeycomb article 100 arranged as a catalyst-loaded ceramic article according to embodiments herein. In FIG. 3, the ceramic honeycomb article 100 comprises a catalyst material deposited as an in-wall portion 112 within a pore structure 114 of the porous ceramic material of the wall 102 and on-wall portion 116 on at least one outer surface of the wall 102 (the on-wall portion 116 shown in FIG. 3 on both outer surfaces of the wall 102). The catalyst material in the in-wall portion 112 and/or on-wall portion 116 may be referred to herein as a coating, deposition, or layer, although as described herein the in-wall portion 112 can be arranged as discrete pockets or islands of catalyst material dispersed throughout the pore structure 114. While the pore structure 114 is illustrated schematically, it is to be understood that the pore structure 114 is an interconnected network of pores, channels, and voids, e.g., as shown in FIGS. 2A and 2B. As described herein, deposition of the in-wall portion 112 of the catalyst material is controlled so that the pore structure 114 retains an empty or unoccupied portion 118 (a portion of the pore structure 114 that is devoid of catalyst material) after the catalyst material deposition process has been completed (e.g., after both the in-wall and on-wall portions have been deposited). The unoccupied portion 118 can be essentially entire void structures, or portions of partially-filled void structures within the pore structure 114.

The volume percentage of the pore structure 114 that is filled by the in-wall portion 112 of the catalyst material may be referred to herein as the pore occupancy or pore volume occupancy. Unless indicated otherwise, the pore occupancy is measured with respect to the percent volume of the pore structure 114 occupied by the catalyst material. In embodiments, the pore occupancy of the in-wall portion is at least about 15% and up to about 85%, such as from 15% to 85% of the volume of the pore structure 114. Accordingly, the unoccupied portion 118 can from 85% to 15% of the total volume of the pore structure 114. In embodiments, the pore occupancy is from 20% to 80%, from 20% to 75%, from 20% to 70%, such as from 30% to 80%, from 30% to 75%, or from 30% to 70%.

By controlling the catalyst deposition process to ensure that the pore structure 114 is not fully filled by the catalyst material (i.e., maintaining a minimum percentage for the unoccupied portion 118), the unoccupied portion 118 provides a pathway for the fluid flow (e.g., exhaust flow) to reach and interact with the in-wall portion 112. That is, the diffusion through the unoccupied portions 118 is significantly faster than diffusion through the catalyst material deposits. Accordingly, the unoccupied portion 118 enables the catalyst material of the in-wall portion 112 to more readily take part in catalytic activity with one or more components (pollutants) of the fluid flow. In this way, by ensuring that the in-wall portion 112 participates in catalytic activity, the overall catalytic performance of the catalyst-loaded ceramic honeycomb article 100 can be increased and/or the total thickness t2 of the on-wall portion 116 can be reduced while maintaining comparable catalytic performance. As described herein, reducing the thickness of the on-wall portion can effectively increase the hydraulic diameter of the channels 106 and thereby reduce backpressure through the honeycomb article 100 in comparison to similarly dimensioned honeycomb bodies having thicker coatings.

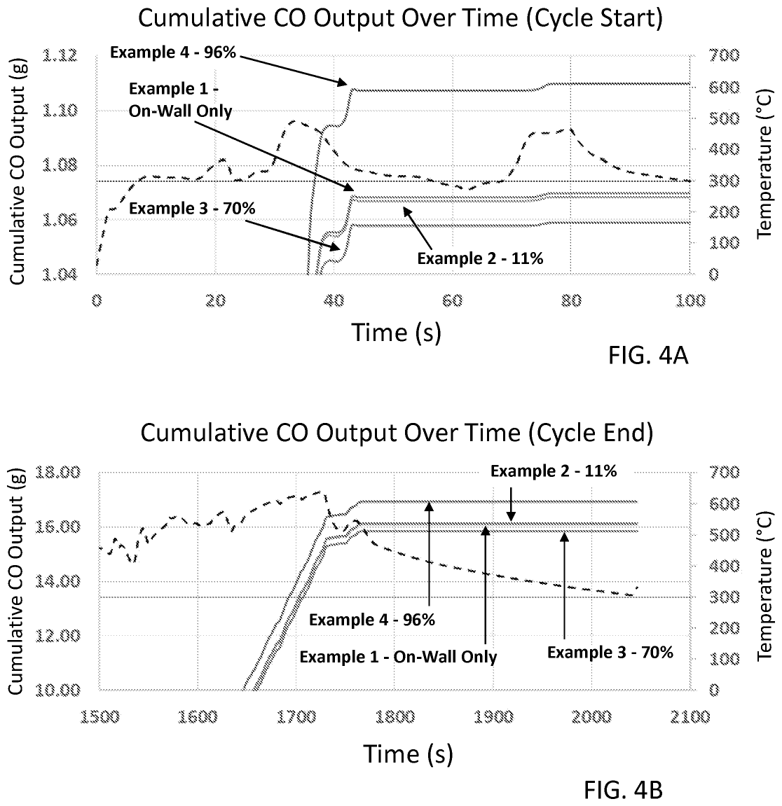

FIGS. 4A and 4B are plots modeling catalyst performance in the form of cumulative carbon monoxide emissions at two different times during engine operation for Examples 1-4 as follows: Example 1 had an on-wall coating only (e.g., a pore occupancy of approximately 0% and/or comprising effectively no in-wall portion 112); Example 2 had an in-wall pore occupancy of 11%; Example 3 has an in-wall pore occupancy of 70%; and Example 4 had an in-wall pore occupancy of 96%. FIG. 4A illustrates a “cold start” situation in the time shortly after an engine is first started (the first 100 seconds), and FIG. 4B illustrates the end of a full simulated engine operational cycle (the last 550 seconds). The solid lines in FIGS. 4A-4B correspond to the performance of Examples 1-4 at the indicated pore occupancies, while the dashed line indicates the simulated temperature of the engine exhaust at the inlet of the honeycomb article (higher temperatures indicating higher simulated levels of engine load). All Examples in FIGS. 4A and 4B had the same total catalyst material loading (i.e., same total weight of catalyst material deposited). Accordingly, the thickness of the on-wall coating is increased with decreasing pore occupancy to maintain the same total catalyst material loading for each Example.

As shown for the scenarios of both FIGS. 4A and 4B, Example 4 having 96% pore occupancy (e.g., 4% of the volume of the pore structure 114 remaining unfilled) had the comparatively worst performance, followed by Example 1 having only on-wall catalyst deposition. Example 2 having 11% pore occupancy had similar results to Example 1, but with slightly improved performance. Example 2 having 70% pore occupancy performed the best in both scenarios.

Without wishing to be bound by theory, it is believed that overall catalytic performance, e.g., as shown for Examples 1-4 in FIGS. 4A-4B, is driven by two primary transport mechanisms for the reactive gaseous species (e.g., pollutants such as carbon monoxide or nitrous oxides) to get access to the reaction sites of the catalyst material, including (1) contact with the catalyst particles at the surface of the on-wall portion 116 as the fluid flows along the channels 106 and (2) diffusion from the surface of the catalyst coating to the catalyst material sites (e.g., catalyst particles) located inside of the catalyst coating. It is believed that the first mechanism is essentially equivalent regardless of the thickness of the catalyst coating, e.g., since the mass transport coefficient is inversely proportional to the channel hydraulic diameter while the exposed surface area is proportional to the hydraulic diameter.

The second transport mechanism relates to the diffusion through the catalyst coating or deposition. When the thickness of the on-wall portion 116 is reduced, the diffusion resistance is correspondingly reduced, which facilitates the ability for reactive gaseous species to access the reaction sites of the catalyst material located within and below the on-wall portion 116. Furthermore, the presence of the unoccupied portions 118 provides relatively faster diffusion pathways for the reactive species of the fluid flow to reach additional reaction sites within the in-wall portion 112. In comparison, if an amount of catalyst material equal to sum of the in-wall portion 112 and the on-wall portion 116 were to all be put on-wall only (thus resulting in a coating being comparatively thicker than the thickness t2), this thicker coating layer would have a comparatively higher diffusion resistance that correspondingly hinders the ability of the reactive gaseous species to access all the reaction sites within the catalyst material. As a result, the catalyst-loaded honeycomb article 100 comprising both the in-wall portion 112 and the on-wall portion 116 offers comparable catalytic performance (conversion efficiency) in comparison to a honeycomb article of same cell density and wall thickness having the same amount of total catalyst material deposited as an on-wall coating only, but with the embodiments disclosed herein providing an advantageously lower backpressure due to the comparatively reduced thickness t2 of the on-wall portion 116 and therefore increased hydraulic diameter of the channels 106.

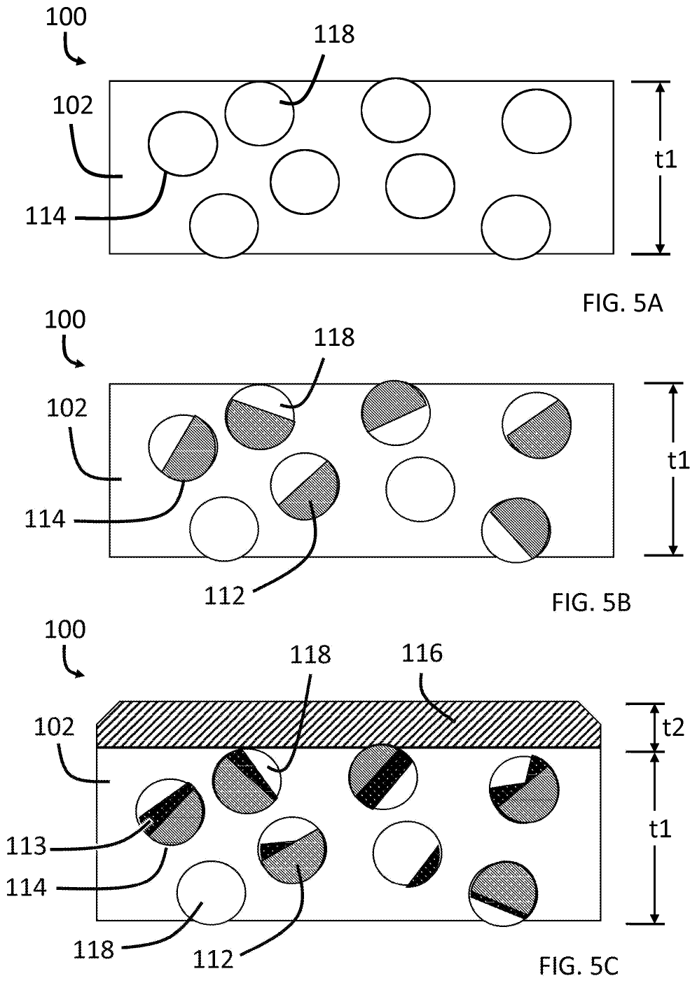

According to embodiments herein, the pore volume occupancy of the in-wall portion 112 and the thickness t2 of the on-wall portion 116 are controlled by a two-step deposition process in which the in-wall portion 112 of the catalyst material is deposited in a first (in-wall) deposition process under a first set of parameters (in-wall deposition parameters) and then the on-wall portion 116 is deposited in a second deposition process under a second set of parameters. For example, FIGS. 5A-5B illustrate three stages of a method for manufacturing a catalyst-loaded ceramic honeycomb article, where the method comprises a two-stage deposition process. Referring to FIG. 5A, the ceramic honeycomb article 100 is first formed, such as by extrusion or other method described herein, with the walls 102 of the ceramic honeycomb article 100 being bare; that is, the pore structure 114 in FIG. 5A is devoid of catalyst material.

In FIG. 5B, the wall 102 is shown after the in-wall portion 112 of the catalyst material has been deposited in the first (in-wall) deposition process. The first set of parameters (in-wall deposition parameters) used during the first (in-wall) deposition process can be selected to ensure infiltration of the catalyst material into the porous structure 114 to yield the in-wall portion 112 of a target pore occupancy, e.g., but without significant creation of the on-wall portion 116.

Next, as shown in FIG. 5C, the on-wall portion 116 can be formed by depositing catalyst material in the second (on-wall) deposition process. The second set of parameters for the second (on-wall) deposition process can be selected to deposit the catalyst material in the on-wall portion 116 to a targeted value of the thickness t2 and/or to reach a target total catalyst loading. In embodiments, the on-wall portion 116 can be formed by the balance of catalyst material remaining to reach a target total catalyst loading after first depositing the in-wall portion 112. For example, if a target catalyst loading of 250 g/L is selected, and 150 g/L of catalyst is deposited to form the in-wall portion 112, then the on-wall portion 116 can be formed having a thickness corresponding to the remaining 100 g/L.

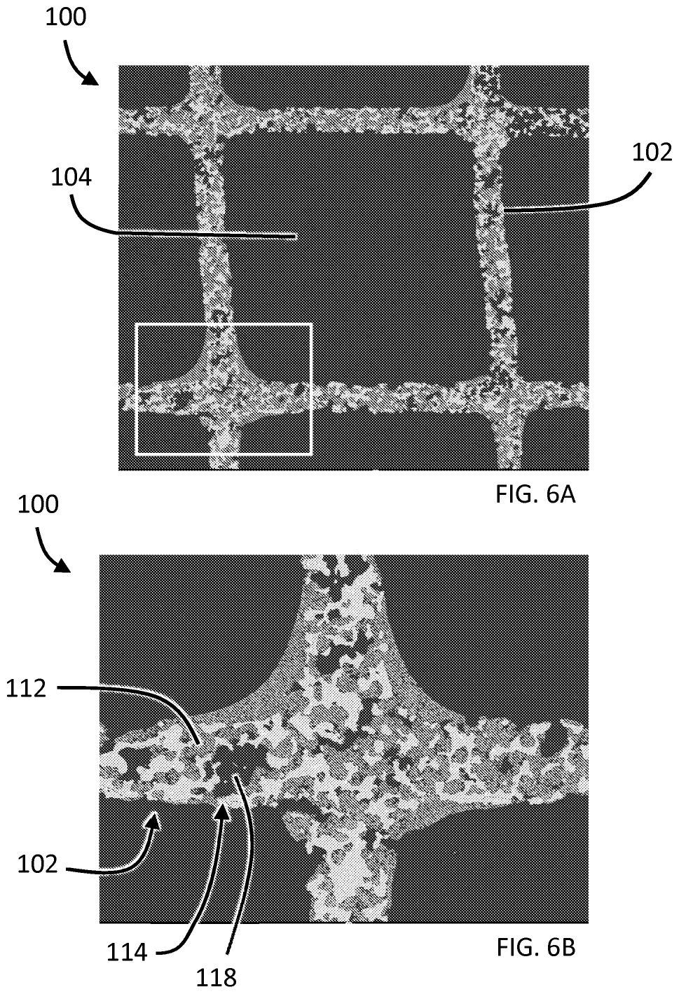

In accordance with the general methodology described with respect to FIGS. 5A-5C, FIGS. 6A-6C are SEM cross-sectional images of the honeycomb body of FIGS. 2A-2B after the first (in-wall) deposition process has been carried out. More particularly, in the example of FIGS. 6A-6B, the in-wall portion 112 has been filled to a pore occupancy of approximately 70%. It is noted that some degree of catalyst material has been deposited on the surfaces of the walls 102, particularly at the corner intersections of the walls 102, but that the vast majority of the catalyst material has been deposited as the in-wall portion 112. For the microstructure characteristics of the illustrated honeycomb body in FIGS. 6A-6C (60% porosity, 600 cpsi, 3.4 mil wall thickness), the shown pore occupancy of approximately 70% is expected to correspond to a total catalyst loading of approximately 140-150 g/L for known three-way catalyst mixtures (washcoat slurries). Accordingly, the on-wall portion 116 can be added in a subsequent on-wall deposition process via a second set of deposition parameters that does not overfill the pore structure 114 of the walls 102 in order to bring the total loading of the catalyst material to a target final or total catalyst loading, e.g., a target catalyst loading of 200 g/L to 350 g/L. In embodiments, the in-wall portion 112 comprises at least 30% of a total catalyst loading (sum of in-wall and on-wall portions) on the ceramic honeycomb article 100. In embodiments, the on-wall portion comprises at least 20% of the total catalyst loading on the ceramic honeycomb article 100. In embodiments, at least 50% of the total catalyst loading is provided by the in-wall portion 112, with the remaining percentage provided by the on-wall portion 116.

It is noted that some amount of catalyst material may be deposited on-wall during the in-wall deposition process (e.g., as shown in FIG. 6C) and that some amount of catalyst material may be deposited in-wall during the subsequent on-wall deposition process. For example, with reference again to FIG. 5C, the second (on-wall) deposition process is illustrated as having also deposited a supplemental in-wall portion 113 (illustrated in black in contrast to the lighter gray color used for the in-wall portion 112 deposited by the first deposition process). However, even if there is some in-wall deposition, the second set of parameters can be set or selected such that the total amount of the in-wall portion 112 (the sum of the gray and black portions in FIG. 5C) is less than the target threshold for the pore occupancy percentage. That is, after the parameters of the first and second after both the first and second deposition processes are carried out, the in-wall portion 112 remains at a pore occupancy that is below a threshold maximum value, e.g., at most 85% occupied, at most 80% occupied, at most 75% occupied, or at most 70% occupied, as described herein.

In embodiments, the first (in-wall) deposition process is carried out to achieve an intermediate target pore occupancy value for the in-wall portion 112 that is less than the final target pore occupancy of the in-wall portion 112 after both the first and second deposition processes are completed. For example, if the target final pore occupancy is selected as 70%, then the pore occupancy after the first deposition process can be a value less than 70%, such as 60%, and the second set of deposition parameters set so that the second deposition process adds an additional 10% or less to the pore occupancy in order to maintain the final pore occupancy under the target value.

The first and second sets of parameters can comprise one or more of: catalyst slurry viscosity, pressure (e.g., vacuum) applied to push/pull the slurry into the porous ceramic material, time span over which the porous ceramic honeycomb article is exposed to the deposition process, solid concentration (particle loading) in the slurry, mean particle size of the catalyst material particles, and/or particle size distribution of particles of the catalyst material. For example, deeper and/or more thorough infiltration into the porous structure, which may be advantageous to deposit the in-wall portion 112 without significant formation of the on-wall portion 116 can be achieved in general by decreasing slurry viscosity, increasing pressure, increasing the duration of the deposition process, decreasing the solid concentration of the slurry, and/or reducing the mean particle size of the catalyst material particles. For example, formation of the on-wall portion 116, e.g., without filling the unoccupied portion 118 remaining after the first deposition process, may be facilitated by increasing viscosity, decreasing application pressure, and/or increasing mean particle size. For example, the first set of parameters can include a viscosity that is less than that used in the second set of parameters, an application pressure that is greater than the second set of parameters, a duration that is longer than that of the second set of parameters, a solid loading that is less than that of the second set of parameters, a mean particle size that is less than that of the second set of parameters, or combinations thereof. Despite two different catalyst deposition processes, the catalyst material (and/or the active component thereof) can be the same, e.g., the catalyst material in both deposition steps can be a three-way catalyst even if some property of the catalyst is different in each step (e.g., different particle size distributions).

In embodiments, each of the first and/or second deposition processes are done in multiple stages to progressively deposit catalyst material to form the in-wall portion 112 over multiple stages. For example, the honeycomb article 100 can be partially-loaded to build up the in-wall portion 112 over several stages and dried between each stage. Similarly, the on-wall portion 116 of the catalyst material can be built up over multiple stages, which together do not overfill the pore structure 114 as described herein. The stages of the in-wall deposition process can be repeated until the pore occupancy of the in-wall portion reaches a threshold or target value. For example, the pore occupancy can be determined by measuring the total amount (e.g., weight) of catalyst added to the honeycomb body, such as by comparing the dry weight of the honeycomb article before and after deposition processes or stages. For example, with knowledge of the closed frontal area (CFA) of the walls 102 of the honeycomb article 100, the axial length of the honeycomb article 100, the porosity (% P) of the material of the walls 102, and the density of the catalyst material, the total weight of the catalyst material corresponding to the selected final target pore occupancy can be approximated or calculated (e.g., total catalyst weight is approximately equal to {CFA*axial length}*{% P}*{% pore occupancy}*{catalyst material density}). Once the pore occupancy (or catalyst solid loading as an analog to the pore occupancy) has reached a target value, the second set of parameters for the second deposition process can be employed to create the on-wall portion 116. As described herein, the second set of parameters can be selected such that the on-wall portion 116 is deposited without reducing the unoccupied portion 118 of the pore structure 114 below a minimum threshold (and/or maintaining the pore occupancy below a target maximum).

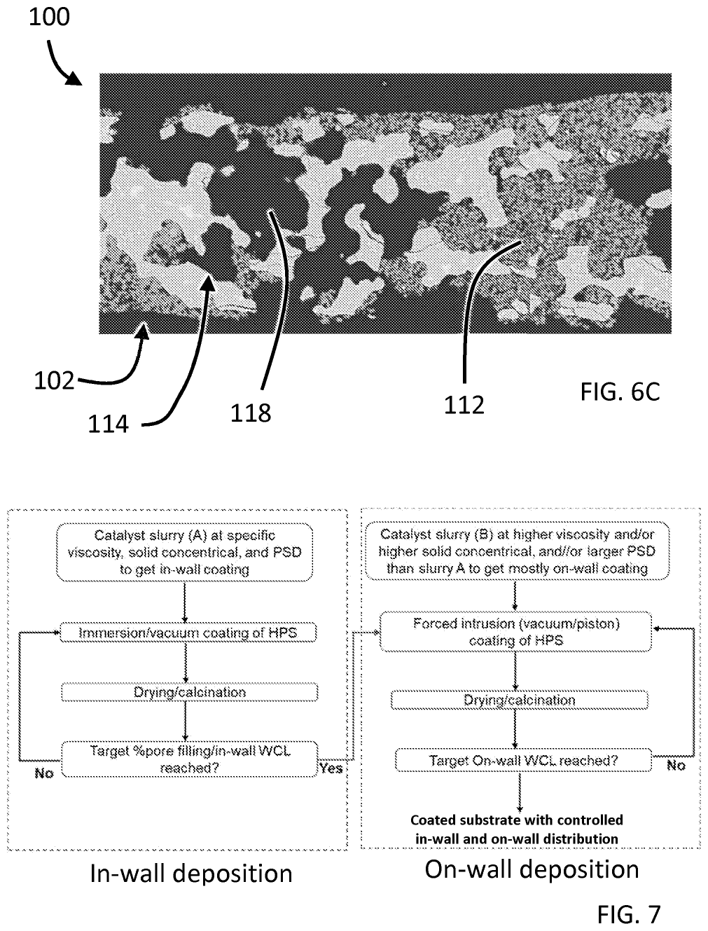

FIG. 7 illustrates a method 700 according to embodiments herein for deposition of the catalyst material as in-wall and on-wall portions. The method 700 correspondingly comprises an in-wall deposition process 702 followed by an on-wall deposition process 704. At step 706, the in-wall deposition process 702 comprises preparing a first catalyst slurry comprising a first set of parameters (e.g., viscosity, solid concentration, particle size distribution). At step 708, the porous ceramic article is exposed to the first catalyst slurry, e.g., immersed in the slurry with or without applied pressure (positive or vacuum). At step 710, the honeycomb article is optionally dried (e.g., via heat, an air flow, or other means). At step 712, it can be determined whether the catalyst material loading has reached the target pore occupancy for the in-wall deposition process 702. For example, step 712 can comprise comparing the dry weight of the ceramic article before and after loading, or subjecting the ceramic article to the first set of parameters for a duration determined to yield the target pore occupancy. As described herein, the target pore occupancy for the in-wall deposition process 702 can be approximately the same as the target final pore occupancy, or a value less than the final target pore occupancy in order to permit some degree of additional in-wall deposition to occur during the on-wall deposition process 704. If the target pore occupancy (e.g., catalyst solid loading) has not been reached, the process 702 can be repeated at step 708 over multiple stages until the target pore occupancy is reached.

Similar to step 704, step 714 of the on-wall deposition process 704 comprises preparing a second catalyst slurry comprising a second set of parameters (e.g., viscosity, solid concentration, particle size distribution). Thus, once the target pore occupancy has been reached in step 712 for the process 702, the partially-loaded ceramic honeycomb article can be exposed to the second slurry at step 716. Similar to step 710, at step 718 the honeycomb article is optionally dried. Similar to step 712, at step 720 it can be determined whether the on-wall portion has reached a target thickness and/or the total catalyst material (sum of in-wall and on-wall portions) has reached a target final or total catalyst loading value.

It will be apparent to those skilled in the art that various modifications and variations can be made without departing from the spirit or scope of the claimed subject matter. Accordingly, the claimed subject matter is not to be restricted except in light of the attached claims and their equivalents.

1. A method of manufacturing a catalyst-loaded ceramic honeycomb article comprising an array of intersecting walls defining channels extending axially through the ceramic honeycomb article, the method comprising:
depositing catalyst material within a pore structure of a porous ceramic material of the walls in a first deposition process comprising a first set of deposition parameters to form an in-wall portion of a catalyst deposition;
depositing catalyst material onto outer surfaces of the walls in a second deposition process comprising a second set of deposition parameters that differ from the first set of deposition parameters to form an on-wall portion of the catalyst deposition;
wherein the second deposition process does not increase the in-wall portion of the catalyst deposition to above a target final pore occupancy of the pore structure.

2. The method of claim 1, wherein a porosity of the porous ceramic material of the walls is at least 50%.

3. The method of claim 1, wherein a porosity of the porous ceramic material of the walls is at least 60%.

4. The method of claim 1, wherein a median pore size of the porous ceramic material of the walls is at least 13 μm.

5. The method of claim 1, wherein a median pore size of the porous ceramic material of the walls is at most one-third of a wall thickness of the walls.

6. The method of claim 1, wherein the first set of deposition parameters and the second set of deposition parameters differ by one or more of a viscosity, an applied pressure during catalyst deposition, a time span over which the porous ceramic honeycomb article is exposed to catalyst deposition, a solid concentration of a slurry comprising the catalyst material from which the catalyst material is deposited, a mean particle size of particles of the catalyst material, a particle size distribution of particles of the catalyst material, or a combination of one or more of the foregoing.

7. The method of claim 1, wherein the first set of parameters includes a viscosity that is less than that used in the second set of parameters, an applied pressure that is greater than that of the second set of parameters, a duration that is longer than that of the second set of parameters, a solid concentration of a slurry comprising the catalyst material from which the catalyst material is deposited that is less than that of the second set of parameters, a mean particle size that is less than that of the second set of parameters, or a combination of one or more of the foregoing.

8. The method of claim 1, wherein the first deposition process comprises depositing the catalyst material to an intermediate pore occupancy that is less than or equal to the target final pore occupancy.

9. The method of claim 1, wherein the first deposition process comprises depositing the catalyst material to an intermediate pore occupancy that is less than the target final pore occupancy and the second deposition process comprises depositing a supplemental in-wall portion to achieve the target final pore occupancy.

10. The method of claim 1, wherein the target final pore occupancy is at most 85%.

11. The method of claim 1, wherein the target final pore occupancy is at most 75%.

12. The method of claim 1, wherein the target final pore occupancy is at least 15%.

13. The method of claim 1, wherein the target final pore occupancy is from 15% to 85%.

14. The method of claim 1, wherein a catalytically active component of the catalyst material is the same for both the first deposition process and the second deposition process.

15. The method of claim 1, wherein the catalyst material in both the first deposition process and in the second deposition process is arranged as a three-way catalyst.

16. The method of claim 1, wherein the catalyst material comprises a combination of alumina, rhodium, and a platinum group metal.

17. The method of claim 1, wherein the first deposition process, the second deposition process, or both, comprise multiple stages.

18. The method of claim 1, wherein the first deposition process, the second deposition process, or both, comprise drying the ceramic honeycomb article after depositing catalyst material.

19. The method of claim 1, wherein the in-wall portion after the first and second deposition processes comprises at least 50% by weight of a total catalyst loading of the catalyst material in the in-wall portion and the on-wall portion.

20. A catalyst-loaded ceramic honeycomb article comprising:
an array of intersecting walls defining channels extending axially through the ceramic honeycomb article, wherein a porous ceramic material of the intersecting walls comprises:
a porosity of at least 60%;
a wall thickness from between 2 mils and 6 mils;
a median pore size of 13 μm to 25 μm; and
a catalyst material deposition comprising:
an in-wall portion occupying from 15% to 85% of a volume of a pore structure of the porous ceramic material; and
an on-wall portion on outer surfaces of the walls within the channels,
wherein the in-wall portion comprises at least 30% of a total loading of the catalyst material and the on-wall portion comprises at least 20% of the total loading of the catalyst material.

21. (canceled)
